(19) United States
(12) Patent Application Publication
(10) Pub. No.: US 2008/0093251 A1
(43) Pub. Date: Apr. 24, 2008

(54) Foam Shipping Package and Method

(76) Inventor: Karl Robert Meyer, Scottsdale, AZ (US)

Correspondence Address: GARY F. WITTING, 5834 EAST OAK STREET, SCOTTSDALE, AZ, 85257, US

(21) Appl. No.: 11/571,745

(22) PCT Filed: Jul. 11, 2005
(86) PCT No.: PCT/US05/24534

§ 371 Date: Jan. 6, 2007

Related U.S. Application Data
(60) Provisional application No. 60/587,389, filed on Jul. 13, 2004.

(51) Int. Cl. B65D 81/03; B29C 41/00; B65D 81/113

(52) U.S. Cl. 206/523; 264/220; 264/299; 53/396

(57) ABSTRACT

A reusable packaging case for an article comprises an inner foam layer having an interior cavity for holding the article. The inner foam layer surrounds at least a portion of the interior cavity. An outer foam layer substantially surrounds the inner foam layer The outer foam layer may have a density greater than the density of the inner foam layer. The inner foam layer may be formed using a plug having the same shape as the article to be later packaged in the case for shipping. The packaging case may optionally contain numerous additional inner foam layers of varying densities and thicknesses. Many substantially identical packaging cases, such as for shipping numerous identical articles coming off of an assembly line, may be formed using the plug.

### RELATED APPLICATIONS

This application is a non-provisional application claiming benefit under 35 U.S.C. sec. 119(e) of U.S. Provisional Application Ser. No. 60/587,389, filed Jul. 13, 2004 by Karl Robert Meyer (titled BIKINI COVERS, INC. HIGH-DENSITY FOAM SHIPPING CASE (HDFC) DETAIL), which is incorporated by reference herein.

### BACKGROUND

1. Field

The present disclosure generally relates to shipping packages, and more particularly to a shipping package using protective foam.

2. General Background

The shipping and packaging industry uses a variety of containers and materials for shipping articles. Foam structures are one form of protective packaging used for shipping. For example, foam pieces may be used on the ends of an article to suspend it within a cardboard box or a wooden shipping crate.

The container designs and materials used to form containers and otherwise package articles are selected based on various factors typically including the desire to minimize shipping weight, the desire to protect the articles from damage during shipment, the logistics associated with stacking and moving the shipping containers (e.g., how the shape of the container may affect handling), and the durability of the container. Also, containers that are reusable are often desired to further help reduce the shipping costs for each article.

Some of the types of fragile articles requiring protective packaging include electrical equipment, military aerospace components, and medical instruments. Larger articles requiring protective packaging include, for example, aircraft engines or parts and large computer towers or consoles.

Shipping containers or crates often are constructed by necessity or business practicality within the manufacturing facility where an article is made. These usually must be constructed with materials that can be fabricated at the facility, or that can be purchased in a generic form and brought to the facility (e.g., such as a steel cargo container). In the foregoing approach, one is often faced with transporting a shipping container or crate having greater weight or a larger size than needed, thus increasing the shipping costs.

Frequently, these containers or cases are very heavy and require large mechanical devices to facilitate their movement. Furthermore, they often do not provide adequate interior protection of the article being shipped. Movement within the interior of the container, such as from shifting or jolting of packaged loads, may damage the packaged articles, which leads to costly damage claims or return of such articles.

Prior containers or crates also often do not provide adequate protection from the weather and all of its elements. The proper handling of moisture or condensation is a common challenge when properly packing the interior of these shipping containers. As an example of one specific form of moisture problem, steel or plywood containers typically will not repel fluid discharge from other shipment containers or crates stacked above it during transport. Containers or crates are often not either reusable or returnable due to the weight or precise nature of their construction, which further may increase shipping costs.

In addition, containers or crates often cannot be inspected during the transportation of the article without unpacking the entire shipment and all its contents. This often requires special tools and significant time of labor that may lead to an inspector having to re-pack the article. However, the inspector typically lacks the appropriate packing expertise to do this re-packing in an optimal way. This lack of expertise typically slows the transport of the articles and may jeopardize the safe shipment of the articles due to the improper re-packing by the inspector.

In view of the foregoing, there is a need for an improved packaging and shipping container or case.

### BRIEF DESCRIPTION OF THE DRAWINGS

For a more complete understanding of the present disclosure, reference is now made to the following figures, wherein like reference numbers refer to similar items throughout the figures:

FIG. 1 illustrates a packaging case and a plug used to form the case, all according to an exemplary embodiment of the present disclosure;

FIG. 2 illustrates an article partially inserted inside a packaging case according to an exemplary embodiment of the present disclosure;

FIG. 3 illustrates the joining together of two structural components of the packaging case of FIG. 2; and

FIG. 4 illustrates a packaging case in an alternative embodiment having an innermost foam layer in addition to an inner foam layer.

The exemplification set out herein illustrates particular embodiments, and such exemplification is not intended to be construed as limiting in any manner.

### DETAILED DESCRIPTION

The following description and the drawings illustrate specific embodiments sufficiently to enable those skilled in the art to practice the systems and methods described herein. Other embodiments may incorporate structural, method, and other changes. Examples merely typify possible variations.

The phrase “shrinkable material” means a material that may be shrunk over an article. The material may be, for example, a shrinkable fabric or a shrinkable polymer film. The phrase “protective layer” means a layer that protects the shrinkable material. For example, the “protective layer” may be polyvinyl alcohol (PVA) or a wax that protects a shrinkable film from styrene in a gel coat or mold layer. The protective layer is not the shrinkable film. Non-limiting examples of shrinkable materials and protective layers are described in U.S. Pat. No. 6,881,370, which is incorporated herein by reference.

The present disclosure describes a high-density foam case (HDFC) that is a form of packaging to protect a product or article for shipping by using multiple densities, for example, of polyurethane or other suitable foam. The HDFC aids in the transportation, shipping, or handling of the product with reduced risk of incurring damage and at typically lighter weights for the packaging case and cost as compared to traditional wood boxes, pallets, containers, dunnage racks, or cradles that would currently be used for the same product.

In one aspect, a reusable packaging case for an article comprises an inner foam layer having an interior cavity for holding the article, and the inner foam layer surrounds the interior cavity. An outer foam layer substantially surrounds the inner foam layer, and the outer foam layer has an average density greater than the average density of the inner foam layer.

In other aspects, the reusable packaging case may include additional foam layers. For example, there may be numerous foam layers of different densities used. The number of such layers might range, for example, from 2-5 foam layers, or in some cases up to 20, or even up to 50, different foam layers (in which each foam layer may have a different density to provide up to 20 or 50 densities).

The general density profile for such numerous layers may be that of the density of the layer touching or closest to the article to be shipped typically selected to correspond to characteristics consistent with direct contact to an article or an article's other shipping coverings. The outer foam layer typically has the highest average density of all or most of the inner layers, with the outer foam layer often having a very high density compared to the inner foam layers. The middle foam layers generally each have an average density that is appropriate for a void fill, with this average density being less than that of the layer in direct contact with or closest to the article to be packaged within.

In one particular manufacturing process, the packaging case may be formed by forming an inner foam layer to have an interior cavity for holding the article by using a plug to define the shape of the interior cavity. The plug has an exterior shape substantially similar to the exterior shape of the article. As is described further below, the plug typically may be removed without getting stuck in the molded foam.

The plug described herein is usually designed to have a “non-negative” exterior shape. As one of skill in the art will understand, a non-negative plug is designed such that an object made from the plug will not have a negative draft. If the plug were negative, it usually could not be readily released from its mold after the plug were formed. In contrast, a non-negative plug (or its corresponding non-negative mold) will permit the release of a part or article from the mold.

The plug may have a rip wire attached to the exterior of the plug before foaming to enhance the separation into, for example, two halves or multiple components or pieces of such foam. The components are placed or mounted together around an article prior to shipment.

The plug may have a release agent sprayed or otherwise applied to the exterior of the plug so the foam will not stick to the plug during formation of the packaging case. Examples of suitable release agents include waxes, PVA, TR mold products, AXEL 424-7 and other water-based releases. As an alternative to a release agent, other materials such as, for example, a plastic film, may be used to permit release of the plug. The release agent and/or other materials may be used to aid in the release of the plug from the foam. The inner foam layer substantially surrounds the plug to form the interior cavity.

Next, an outer foam layer is formed substantially surrounding the inner foam layer. The outer foam layer is formed to have an average density greater than the average density of the inner foam layer. The inner foam layer also may substantially surround the rip wire if used, and the two ends of the rip wire may lead out to the exterior of the next density of foam.

Then, the plug is removed from the interior cavity (e.g., by pulling the rip wire around the periphery of the two or more multiple densities of foam provided as part of the packaging case). For example, pulling the rip wire opens the case for the removal of the interior plug and prepares the packaging case for receiving the actual article to be shipped. It should be noted, however, that other manufacturing processes differing from the foregoing process may be used to create the structure of the packaging case described herein.

In another exemplary manufacturing process, the plug may have a rip wire, which is attached to (or around) the exterior of the plug before foaming, to permit the improved separation into two halves (or other number of multiple components or pieces) of foam. The plug typically has a release agent sprayed or applied to the exterior of the plug so the foam will not stick to the plug. Other materials in addition to or as an alternative to the release agent may be used to aid in the easy release of the plug from the foam. The inner foam layer substantially surrounds the plug and the rip wire to form the interior cavity. The rip wire may be pulled out and around the periphery of the foamed article to separate the two or multiple components or pieces of foam so that the plug may be removed.

Continuing with the manufacturing process, the two or multiple components (which together will provide the inner foam layer to protect an article during shipment) are fit back together, without the plug in the interior, and fastened closed, for example, with tape. Next, an outer foam layer is formed substantially surrounding the inner foam layer. The outer foam layer is formed to have an average density greater than the average density of the inner foam layer. The outer foam layer may be designed to have a shape that is square, rectangular or another shape (e.g., the shape of the interior of an aircraft in which the packaging case will be shipped).

In yet another exemplary manufacturing process, the plug may rest on a flat surface (e.g., a table) during formation of the packaging case. The plug and/or flat surface typically may have a release agent sprayed or applied thereon so that foam will not stick to the plug or flat surface during manufacture of the packaging case. The release agent and/or other materials may be used to aid in the easy release of the plug and flat surface from the foam. The inner foam layer is formed to substantially surround the top of the plug and the flat surface to form the interior cavity.

Next, an outer foam layer is formed substantially surrounding the inner foam layer. The outer foam layer is typically formed to have an average density greater than the average density of the inner foam layer. The outer foam layer, which provides the exterior shape of the packaging case, may be designed to have a shape that is, for example, square or rectangular, and may optionally have feet or legs mounted to the exterior to aid in the handling of the packaging case. Once the foaming is completed, the plug may be separated from the flat surface and turned over so that the plug may be removed. The package case is now ready to receive an article to be shipped. This type of packaging case is sometimes characterized by one of skill in the art as being a “one-sided” container or a “drop-in.”

It should be noted that the above one-sided packaging case will typically substantially contain the entire article without a top or second component or piece. It is also evident that the one-sided packaging case may have a top component made to mate with the one-side packaging case in order to further or fully enclose the top or exposed end of the article.

In still another exemplary manufacturing process the plug is cut in half or into another cross-section. One of the halves is laid on a table or other flat surface, and a release agent is sprayed or applied to the exterior of the plug and table so as the foam will not stick to the plug or table. The inner foam layer is formed to substantially surround the plug and a portion of the flat surface of the table (i.e., a portion of the flat surface around the circumference of the portion of the plug in contact with the flat surface) to form the interior cavity.

Next, an outer foam layer is formed to substantially surround the inner foam layer. The outer foam layer is formed to have an average density greater than the average density of the inner foam layer. The outer foam layer may have, for example, a square or rectangular shape and may include feet or legs to aid in handling of the packaging case during shipment of an article.

Once foaming is complete, the plug may be separated from the flat surface and turned over so that the plug may be removed. This component will, for example, now be able to contain half of the article to be shipped. A second mating packaging case component may be formed, using the same or a similar process as just described for the first case component, by using the other half of the plug.

In yet a further exemplary manufacturing process that is a variation from the above, the half portion of the plug used to form the first packaging case component may be separated from the flat surface and turned over so that the plug may be removed. As described above, this component is able to hold half of an article, typically in an exact or near-exact fit. The two halves of the plug may then be fastened together, and the already used-end of the plug re-inserted back into the already-formed first half of the packaging case in order to perform the fabrication of the second component.

A release agent is then sprayed or applied over the entire exposed surface of the plug and the first component so additional foam to be added will not stick to the first component or plug. The release agent and/or other materials such as, for example, tape may be applied to the top of the first component to aid in the release of the first component from the new foam used to form the second component. The foregoing process provides two component halves that may be used to provide an exact or near-exact fit to an article without requiring the use of a rip wire as discussed earlier above or the cutting of the components to access and remove the plug.

As an option, it should be noted that after the packaging case components, or the one-sided packaging case discussed above, have been made, a mold for each component of a packaging case may be made to further expedite the manufacturing process for additional packaging cases of the same type.

The mold may be made from the entire packaging case, which would include the exterior or vertical walls and the interior cavity plug. In some cases, the walls or exterior molds may be permanently affixed or attached to the interior plug. In other cases, the exterior mold and the interior plug may be detachable from one another to aid in the removal of the packaging case once made.

This use of a mold may assist in manufacturing because the components of the packaging case are now are in exact or substantially exact proximity to one another within their own separate molds. It should be noted that when the interior cavity is formed, one half of the cavity may be positioned in the same general proximity as the other half of the cavity so that the two interior and exterior packaging case components mate in a more perfect manner.

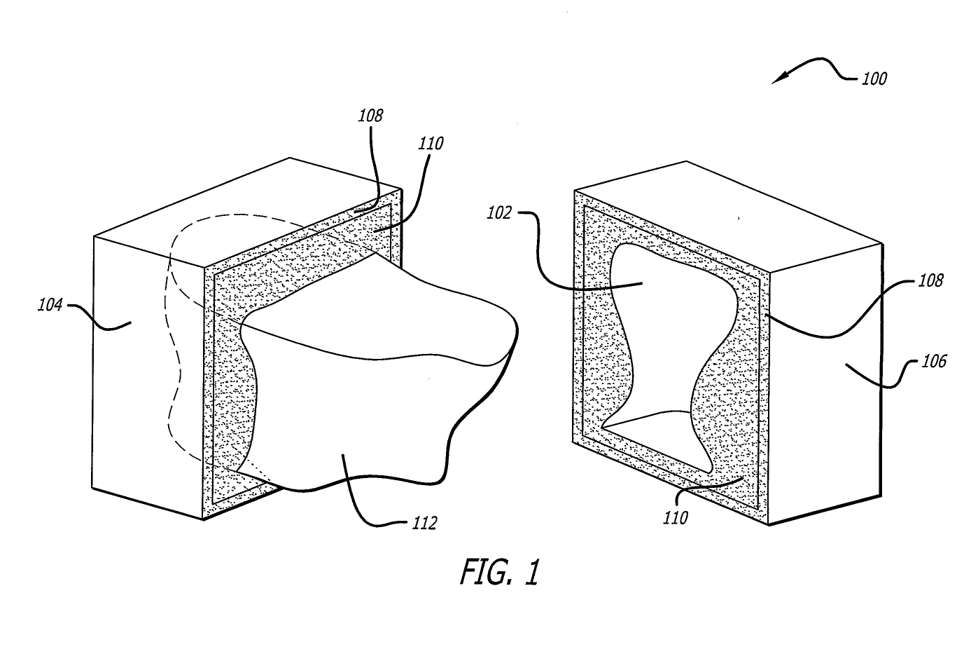

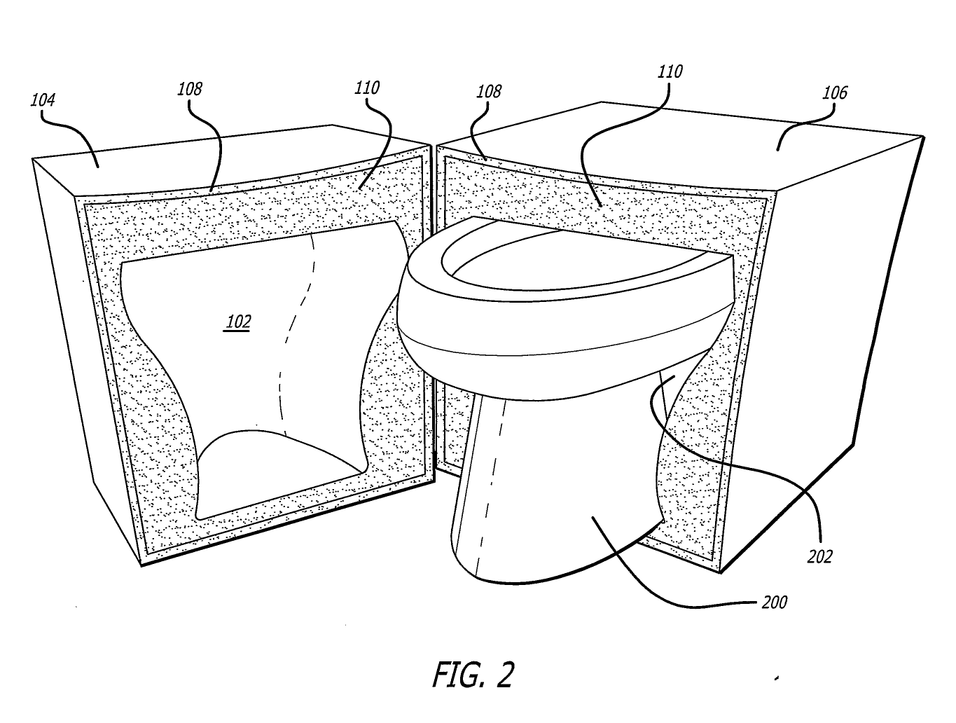

The structure, use and manufacture of an embodiment of the packaging case is now described further with reference to FIGS. 1-3. FIG. 1 illustrates a packaging case 100 having an interior cavity 102 and formed of two components 104 and 106 that join together to protect an article (shown later in FIG. 2). An inner foam layer 110 will surround the article to protect it during shipping, and an outer foam layer 108 will surround inner foam layer 110 to provide a more rigid external shape, for example a rectangular shape, for shipping. For example, outer foam layer 108 may be formed as a thin, substantially rigid shell in a rectangular shape. Other shapes may also be used.

Outer foam layer 108 may be, for example, thinner in its thickness than inner foam layer 110 in most or all regions of outer foam layer 108. For example, the average thickness of outer foam layer 108 may be less than about 50% of the average thickness of inner foam layer 110. Outer foam layer 108 is typically a thin, harder shell relative to inner foam layer 110.

Outer foam layer 108 is usually designed to be suitably thick (e.g., suitable for the desired packaging case rigidity or exterior impact protection) given the density of the foam selected based on the size or weight of the article. A suitable range of thickness for outer foam layer 108 is, for example, about ⅙ to 1 inch. Outer foam layer 108 may be, for example, ½ inch thick when using a 10 lb/ft³ density foam, whereas for a 20 lb/ft³ density foam, outer foam layer 108 may be only ¼ inch thick.

The thickness of outer foam layer 108 is often dictated by the extent of handling the case will receive over its usage life and the weight of the article. For example, the total weight of outer foam layer 108 in the two example densities described above is about the same, but the use of one of the densities over the other in outer foam layer 108 may provide better durability.

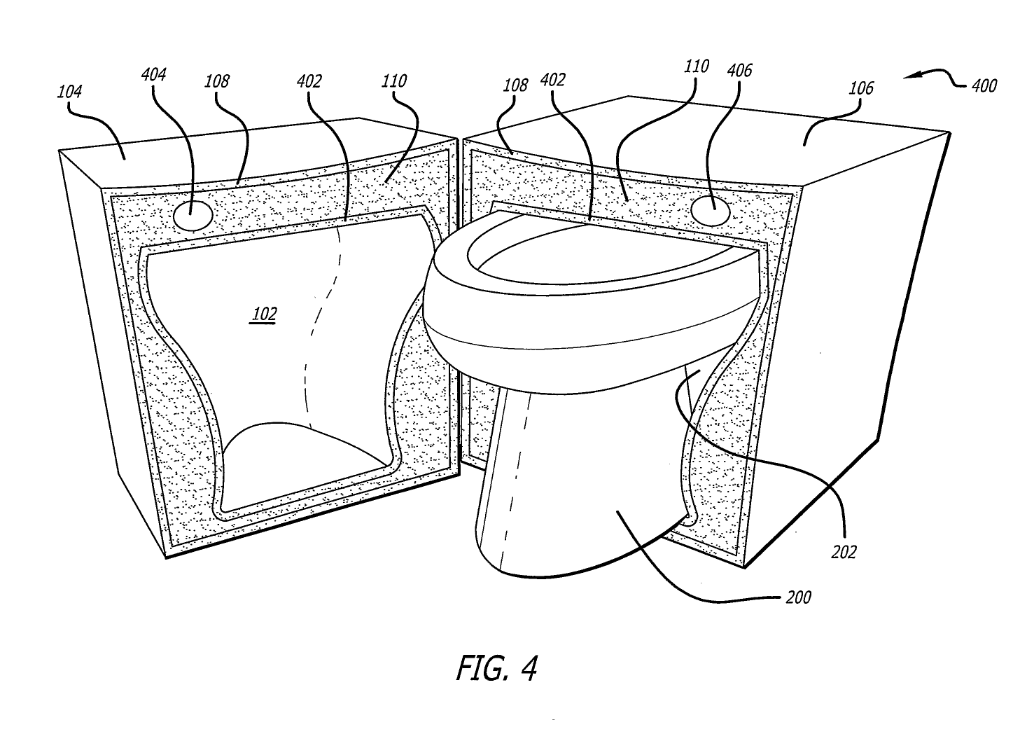

The relationship between the choices of foam density that may be used for inner foam layer 110 is similar to that described above with respect to outer foam layer 108. For example, a 0.05 lb/ft³ density of foam in inner foam layer 108 is typically appropriate for a smaller item, for example, like a book, but a 4 lb/ft³ density of foam is typically needed for a larger item, for example, like an aircraft engine. When more than two foam layers are used in packaging case 100, the foam layer or layers positioned between the foam layer closest to article 200 (e.g., innermost foam layer 402 shown in FIG. 4) and outer foam layer 108 would typically each have a density selected appropriate for use as a void fill to assist in reducing the overall weight of packaging case 100.

Optionally, “voids” or hollow spaces (e.g., similar to voids 202 discussed below) may be intentionally introduced into the interior of packaging case 100, or optionally between two inner foam layers, by inserting balloons or other similar space fillers during manufacture of the packaging case. These space fillers are usually not removed after a foam layer is formed, but instead remain within the structure of packaging case 100. The use of these voids creates hollow spaces that typically decrease the weight and material needs of the packaging case.

A plug 112 may be used to form interior cavity 102 for later insertion of the article for shipping, as described further below. Plug 112 is removed after forming packaging case 100 so that an article may be inserted into interior cavity 102.

FIG. 2 illustrates an article 200 partially inserted inside packaging case 100. Component 106 is fitted onto one end of article 200. Inner foam layer 110 may be formed to substantially conform to and fit the exterior shape of article 200, but typically smaller voids 202 may remain after article 200 is surrounded by inner foam layer 110. Also, larger voids in addition to voids 202 may be intentionally formed as desired for various shipping or handling purposes.

Each of the two components 104 and 106 may provide about half of the packaging case, and are separable for inserting and removing article 200 into and from packaging case 100. Note that in other embodiments, packaging case may comprise three or more components that together are used to protect an article for shipping. Also, when two or more components are used to form the packaging case, the components may be, for example, taped, strapped or latched together to encapsulate an article. The components may also be foamed close to encapsulate the article for certain applications.

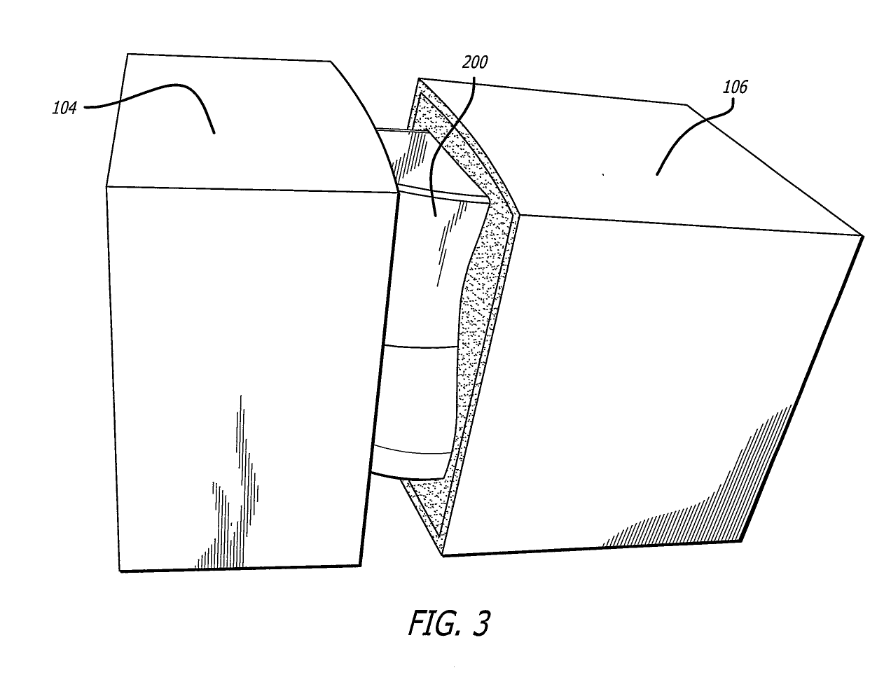

FIG. 3 illustrates the joining together of components 104 and 106 around article 200. In preparation for shipping, components 104 and 106 are positioned to fully enclose article 200 (or alternatively to enclose article 200 for shipping, but with some gap remaining between components 104 and 106). Packaging case 100 may optionally incorporate wood, steel, or laminates (not shown) in the foam to further strengthen or secure the foam or the article. Also, packaging case 100 may incorporate locking devices (not shown) to prevent unauthorized removal of the article from the interior of packaging case 100.

Packaging case 100 may include interior cavities (not shown) for holding other articles in addition to article 200. These articles may be, for example, a group of related articles used in manufacturing a particular module or sub-assembly upon arrival at a shipping destination.

Inner foam layer 110 may have an average density greater than, for example, about 0.05 lb/ft³, with a typical range, for example, between about 0.05 to 6 lb/ft³. Outer foam layer 108 may have an average density greater than, for example, about 10 lb/ft³, with a typical range, for example, between about 10 to 70 lb/ft³. The average density of outer foam layer 108 may typically be, for example, more than 1,000% greater than the average density of inner foam layer 110. Multiple combinations of densities for each of the foam layers may be used for different levels of protection.

In some instances, by way of example, a one-side packaging case or drop-in case designed for use in shipping a transmission, made of cast aluminum and weighing about 60 lbs., has an average density for outer foam layer 108 of 10 lb/ft³ to cradle the article and protect the exterior. Also, optionally, a second outer foam layer (not shown) may be used having the same average density. Inner foam layer 110 has an average density of 3 lb/ft³.

In regards to larger or heavier objects, for example, weighing 600 lb. or more, outer foam layer 108 may have, for example, a ½ inch thickness and an average density of about 20 lb/ft³. Inner foam layer 110 may have, for example, an average density ranging from about 2 to 4 lb/ft³.

The average density for each of multiple inner foam layers, when used, may vary in a decreasing manner moving from the outside towards interior article. The foam layer closest to the article (e.g., a larger object) may have an average density, for example, of about 2 to 4 lb/ft³, or alternatively have the same average density as outer foam layer 108. The density and thickness of outer foam layer 108 are typically selected based on considerations related to handling and durability in transport. The density of inner foam layer 110, and other inner foam layers when used, is typically selected to use the lowest density that is consistent with maintaining the integral support and protection by the inner foam layers of the article being shipped.

Typically, the foam layers in the packaging case are touching, or joined or bonded together, as each next density of foam layer is applied (e.g., by spraying) over the previously formed foam layer. The foam used to form each of these layers may be, for example, sprayed in thicknesses for each of many successive layers that when applied may vary by only about ⅙ inch. The various layers of foam thicknesses may be applied in some cases such that the final collection of numerous layers acts as a single foam layer (except to the extent that non-foam articles such as metal or space fillers like balloons are used during manufacture). For example, numerous applications of foam may be successively sprayed to form a single foam layer, which will have substantially constant characteristics such as, for example, the average density of the foam in the final foam layer.

Inner foam layer 110 and outer foam layer 108 may each be formed, for example, using polyurethane. Other materials may be used. For example, most suitable foams have a resin base that can be expanded into a foam material.

In one aspect, outer foam layer 108 may be sprayed onto the interior walls of a mold (not shown). This mold will typically provide the exterior shape of packaging case 100 (e.g., its square or rectangular shape), and the mold includes interior vertical walls that in part define the shape for the exterior surface. The plug, which is positioned or resting inside the interior walls of the mold, will substantially shape the interior cavity for the article to be shipped.

When applying the foam, for example, on one half of the packaging case, it may be desirable to first spray the higher density foam, which will form outer foam layer 108, onto the interior vertical walls of the mold. Next, foam of a different density (e.g., foam that will be used to form inner foam layer 110) may be sprayed onto and around plug 112, which is still positioned in the mold. Foam of other densities may then be applied, which may be used to fill the void or space between the foam layer closest to interior cavity 102 (see, e.g., innermost foam layer 402 in FIG. 4 below) and outer foam layer 108. The higher density foams that are typically used to form outer foam layer 108 usually do not significantly expand during application and may be, for example, sprayed similarly as a paint so that with suitable equipment the foam is readily applied.

The density of the foam may be formulated at the factory by the supplier for the specific shipping application and/or the desired packaging case manufacturing process. Also, the formulation typically may be optionally adjusted for factors such the rate at which the foam expands and/or dries after leaving a spray gun (not shown). In some cases, it is desired that the foam expand and dry within a few seconds of leaving the spray gun nozzle so the foam sticks to the vertical walls of the mold. If the foam were to expand more slowly, it usually would not adhere to the vertical walls of the mold, which has been covered with a release agent to that keep the foam from permanently bonding to the mold.

For some foams, particularly the lower density foams, it is desired that the foam expand slowly so as, for example, to be blown through rigid substrates (e.g., perforated lath or metal substrates) that may be inserted into or between the foam layers during manufacture. Also, It should be noted the rate of foam expansion usually does not change the final density of the dried foam layer.

Outer foam layer 108 often aids in providing structural strength to packaging case 100 in part because it is supported or reinforced by the inner foam layer or layers (e.g., inner foam layer 110). The fact that these foam layers are all bonded, joined, or welded to one another is believed to be a possibly significant factor in providing structural strength (e.g., the structure may act somewhat like a “unibody”). Other features that may provide structural strength include, for example, perforated lath, sheet metal, extruded aluminum or steel that are incorporated in, with or around the inner foam layer or layers during manufacture of packaging case 100. Fiberglass or wood also may be similarly incorporated, but often these materials are not preferred due to their greater weight and cost.

In one approach, packaging case 100 may be formed by first forming inner foam layer 110 around plug 112, which defines the shape of interior cavity 102 to later contain and protect article 200. The inner foam layer 110 has an average density greater than, for example, about 1 lb/ft³ and substantially surrounds interior cavity 102. The plug 112 has an exterior shape substantially similar to the exterior shape of the article 200.

Next, outer foam layer 108 is formed to substantially surround inner foam layer 110. Outer foam layer 108 has an average density greater than the first average density. For example, outer foam layer 108 may have a density greater than about 10 lb/ft³.

After forming outer foam layer 108, plug 112 is removed from interior cavity 102 to prepare packaging case 100 for receiving article 200. The plug is typically removed from one of two methods of fabrication discussed below. Other methods may alternatively be used.

In the first method, the foam layers are formed over article 200 while it is resting on a flat surface, which can be used to provide a one-sided packaging case as described above. This method allows the removal of the package case from the flat surface and the plug, with the side of the package case that was mated to or resting on the flat surface usually being substantially flat like the surface. By removing the entire formed foam piece from the flat surface, the plug may be readily removed.

In the second method, a rip wire or cord is taped or attached to the circumference of plug 112 with a leader that will extend out to the exterior of the foam layer or layers to be applied. By foaming over the rip wire or cord and pulling the leader after the foam is dry, the foam may be cut into two separate halves or components. This in turn permits access to plug 112 for removal.

It should be noted that plug 112 may be removed before all of the foam layers, such as outer foam layer 108 and/or multiple inner foam layers, have been fully formed. It should also be noted that the rip wire should be attached to avoid the plug getting stuck in the foam, and in some cases multiple rip wires or cords may be needed. Note that each packaging case 100 may be reused many times to ship or protect numerous additional articles that are the same or substantially identical in exterior shape to article 200.

In one specific approach, inner foam layer 110 may be formed using a shrinkable material (not shown). The shrinkable material may be positioned over at least a portion of a representative article, such as article 200, to be packaged using packaging case 100. The shrinkable material is then shrunk, and a mold (not shown) is formed by placement over the shrinkable material. Plug 112 is then formed using the mold.

The most commonly used materials for these plugs and molds may be standard or high-grade fiber reinforced plastics (FRPs) and gel coats. For the purpose of explanation, we generally refer to concave surfaces as molds and convex surfaces as plugs. Also, it should be noted generally that a mold may be created from a plug, and a plug may be created from a mold.

Molds and plugs may be made quickly or slowly and with a variety of starting materials, which are selected based, for example, on how many times the mold or plug will be used. When only one packaging case or plug will be created, the process may be expedited by using, for example, only gel coat and foam. When multiple packaging cases of a particular type will be created, gel coat and FRP, which has a higher tolerance to heat distortion from the chemical reaction that typically occurs with foam products, are preferred for use.

A common form of molding is where a gel coat (e.g., a durable paint) is sprayed over a mold or plug after a mold release has been applied to its surface. Once the gel coat has tacked off (e.g., about one hour after application), the fiber glass and resin is applied to the gel coat surface. Once the FRP is dry, the mold or plug can be removed and a release agent applied to limit or prevent the foam from sticking or attaching itself to the mold or plug. It also can be appreciated that a faster way of molding is to apply foam over the gel coat for foams having sufficiently quick drying times.

The shrinkable material mentioned above may be, for example, a heat shrinkable polymer. Also, a protective layer may be optionally applied covering a surface of the shrinkable material before forming the mold. The protective layer may be, for example, polyvinyl alcohol (PVA). The mold may be formed, for example, using fiberglass. Additional information on the foregoing specific approach is described in U.S. Pat. No. 6,881,370 (titled METHOD FOR FABRICATING A HARD COVER FOR AN ARTICLE by Karl R. Meyer and issued Apr. 19, 2005), which is hereby incorporated by reference.

A non-negative shape of an item such as article 200 optionally may be formed fairly quickly and inexpensively as described in U.S. Pat. No. 6,881,370. The approach described therein permits one to create a non-negative shape of an article called a “plug” (e.g., plug 112 in FIG. 1 above). The plug may be fairly easily removed from most substrates once a release agent is added to the exterior surface. The plug may be used to create a number of covers for the article (e.g., a hard case cover). It should be noted that alternative methods other than that described in U.S. Pat. No. 6,881,370 may be used to form inner foam layer 110.

By, for example, blowing foam around plug 112 and encapsulating it in the foam, one can readily remove the plug once the foam is cut open. This permits the article for shipping to be readily placed in and removed from the foam form, hence making the foam surrounding the plug a reusable protective cocoon.

In one exemplary approach, fiberglass reinforced plastic (FRP) open molds may be used to create relatively inexpensive plugs for the formation of the packaging case 100 described herein. A large number of such packaging cases then could be created using the plug and sold to packaging or transport companies. These packaging cases may be created on-site or delivered to a manufacturer for use.

Outer foam layer 108 may be formed using a higher density foam that is shaped into, for example, rectangular shapes for convenient stacking and shipping. This allows less damage and lighter package weights when shipping or transporting the article, typically due in part to the more exacting or conforming exterior size and shape.

Many substantially identical packaging cases, such as for shipping numerous identical articles coming off of an assembly line, may be formed using the plug 112. For example, a packaging case manufacturer may use plug 112 to manufacture a large number of cases to be sold for use at a customer's facility its products are manufactured. The packaging case and methods described herein permit the shipping containers to be made at a different facility than where the final packaging occurs.

The outer periphery of packaging case 100 may have legs or handles (not shown) added to accommodate special shipping or handling needs. For example, slots (not shown) may be provided on the bottom of case 100 to permit a pallet-jack to slide under case 100.

In addition to the articles described above, other items such as, for example, radio frequency identification (RFID) tags or global positioning system (GPS) units may be enclosed or included within packaging case 100 to assist with tracking during shipping. Also, packaging case 100 may be formed so it can be sealed closed to be evacuated or charged with an inert gas.

FIG. 4 illustrates a packaging case 400 in an alternative embodiment having an innermost foam layer 402. Case 400 is similar to case 100 above, but innermost foam layer 402 has been added during the manufacture of case 400. Innermost foam layer 402 substantially surrounds interior cavity 102 and typically has an average density greater than the average density of inner foam layer 110. Innermost foam layer 402 may be formed as a substantially thin layer relative to the thickness of inner foam layer 110.

Innermost foam layer 402 typically will be in direct contact with substantial portions of the exterior of article 200 and typically is the foam layer in packaging case 400 positioned closest to article 200. Innermost foam layer 402 may be formed using the basic manufacturing process described above.

Space fillers 404 and 406 may be incorporated into the interior of packaging case 400 as described earlier. Here, space fillers 404 and 406 are, for example, balloons. Additional balloons and/or other space fillers may be used when forming packaging case 400.

By the foregoing disclosure, an improved structure and method for a packaging case has been described. The packaging case is more versatile than traditional crating because it is not limited to square or rectangular shapes. Also, the case is typically a fraction of the weight of traditional crates or boxes, costing less to ship, and is typically less expensive to create. For example, expensive shipping materials such as popcorn, peanuts, and Styrofoam typically are not required. In addition, the packaging case described herein can be made to be reusable without costly assembly.

The foregoing description of specific embodiments reveals the general nature of the disclosure sufficiently that others can modify and/or adapt it for various applications without departing from the generic concept. For example, in other embodiments additional layers of inner or outer foam may be used around or within foam layers 108 and 110, with each additional layer optionally having a different density and/or using different materials. Also, each foam layer may comprise other suitable materials, as a mixture or otherwise, in addition to the foam itself. Therefore, such adaptations and modifications are within the meaning and range of equivalents of the disclosed embodiments. The phraseology or terminology employed herein is for the purpose of description and not of limitation.

1. A reusable packaging case for an article, comprising:
an inner foam layer having an interior cavity for holding the article, wherein the inner foam layer has a first average density and substantially surrounds the interior cavity; and
an outer foam layer substantially surrounding the inner foam layer, wherein the outer foam layer has a second average density greater than the first average density.

2. The packaging case of claim 1 wherein the inner foam layer has an average density greater than about 1 lb/ft³ and the outer foam layer has an average density greater than about 10 lb/ft³.

3. The packaging case of claim 1 further comprising an innermost foam layer substantially surrounding the interior cavity, wherein the inner foam layer substantially surrounds the innermost foam layer and the innermost foam layer has an average density greater than the first average density.

4. The packaging case of claim 3 further comprising an additional foam layer disposed between the inner foam layer and the outer foam layer, wherein the additional foam layer has an average density less than the second average density and less than the average density of the innermost foam layer.

5. The packaging case of claim 1 further comprising:
one or more additional foam layers disposed in the packaging case between the interior cavity and the outer foam layer, wherein each of the one or more additional foam layers has a different density; and
one or more rigid substrates positioned in or between at least some of the one or more additional foam layers.

6. The packaging case of claim 1 wherein the second average density is more than 1,000% greater than the first average density.

7. The packaging case of claim 1 comprising two components that together substantially surround the article, and wherein each of the two components comprises a portion of the inner foam layer and the outer foam layer.

8. The packaging case of claim 7 wherein each of the two components provides about half of the packaging case.

9. The packaging case of claim 7 wherein a portion of the article is visible after the two components are mounted to substantially surround the article.

10. The packaging case of claim 7 wherein the two components are separable for inserting and removing the article into and from the case.

11. The packaging case of claim 7 wherein the article is a first article, the interior cavity is a first interior cavity, and the packaging case comprises a second interior cavity for holding a second article.

12. The packaging case of claim 1 wherein the outer foam layer is a thin, substantially rigid shell formed into a substantially rectangular shape suitable for shipping the article.

13. The packaging case of claim 12 wherein the outer foam layer is formed in substantially direct contact with the inner foam layer.

14. The packaging case of claim 10 wherein the inner foam layer within each of the two components is a substantially continuous integral layer and substantially conforms to the exterior shape of the article.

15. The packaging case of claim 12 wherein the average thickness of the outer foam layer is less than about 50% of the average thickness of the inner foam layer.

16. The packaging case of claim 1 wherein one or both of the inner foam layer and the outer foam layer comprise polyurethane.

17. A method for forming a packaging case for shipping an article, the method comprising:
forming an inner foam layer to have an interior cavity for holding the article using a plug to define the shape of the interior cavity, wherein the inner foam layer has a first average density and substantially surrounds the interior cavity and the plug has an exterior shape substantially similar to the exterior shape of the article;
forming an outer foam layer substantially surrounding the inner foam layer, wherein the outer foam layer has an second average density greater than the first average density; and
removing the plug from the interior cavity to prepare the packaging case for receiving the article.

18. The method of claim 17 wherein removing the plug comprises separating two components that together substantially surround the article, and wherein each of the two components comprises a portion of the inner foam layer and the outer foam layer.

19. The method of claim 18 further comprising inserting the article into the interior cavity by bringing the two components together to surround the article within the inner foam layer.

20. The method of claim 17 wherein forming the inner foam layer comprises:
positioning shrinkable material over at least a portion of a representative article to be packaged;
shrinking the shrinkable material;
forming a mold by placement over the shrinkable material; and
forming the plug using the mold.

21. The method of claim 20 further comprising making more than five substantially identical packaging cases using the plug for use in shipping a plurality of substantially identical articles corresponding to the representative article.

22. The method of claim 20 wherein the shrinkable material is a heat shrinkable polymer.

23. The method of claim 20 wherein forming the inner foam layer further comprises applying a protective layer covering a surface of the shrinkable material before forming the mold.

24. The method of claim 23 wherein the protective layer is polyvinyl alcohol.

25. A reusable packaging case for an article, wherein the case comprises two components adapted to fit onto opposite ends of the article in preparation for shipping or other handling, each of the two components comprising:
an inner foam layer having an interior cavity for holding a portion of the article, wherein the inner foam layer has a first density and substantially surrounds the interior cavity; and
an outer foam layer substantially surrounding the inner foam layer, wherein the outer foam layer has a second density greater than the first density.

26. The packaging case of claim 25 wherein the two components, when fully mounted, do not fully cover the article.

27. The packaging case of claim 25 wherein the two components, when fully mounted, substantially cover the full exterior shape of the article.
